(19) United States
(12) Patent Application Publication
(10) Pub. No.: US 2026/0004284 A1
(43) Pub. Date: Jan. 1, 2026

(54) MULTI-FACTOR DATA CERTIFICATION

(71) Applicant: INKAN.LINK, Crolles (FR)

(72) Inventor: Nicolas Thomas, Crolles (FR)

(21) Appl. No.: 18/841,873

(22) PCT Filed: Mar. 1, 2023
(86) PCT No.: PCT/EP2023/055078

§ 371 Date: Mar. 6, 2025

(30) Foreign Application Priority Data
Mar. 1, 2022 (FR) FR2201791

(51) Int. Cl. G06Q 20/38

(52) U.S. Cl. CPC G06Q 20/3825; G06Q 20/3827; G06Q 20/3829

(57) ABSTRACT

A module for processing certifying instances of digital data comprises a public key of the user and of certifying systems, wherein each of the certifying instances is associated with a storage address, with a user terminal, and with a non-repudiable ledger comprising an ordered list of elements. Each of the elements comprises: an attestation generated by one of the certifying systems, an attestation comprising a type of attestation, a document hash, a time stamp by the certifying system of the time at which the attestation was generated; an electronic signature of the attestation; a time stamp by the processing module of the time at which the element was added to the ordered list; and possibly a pointer to the document.

### CROSS REFERENCE TO RELATED APPLICATIONS

This application is a national phase entry under 35 U.S.C. § 371 of International Patent Application PCT/EP2023/055078, filed Mar. 1, 2023, designating the United States of America and published as International Patent Publication WO 2023/166009 A1 on Sep. 7, 2023, which claims the benefit under Article 8 of the Patent Cooperation Treaty to French Patent Application Serial No. FR2201791, filed Mar. 1, 2022.

### TECHNICAL FIELD

The present disclosure lies in the field of computer encryption and systems guaranteeing non-repudiation, such as blockchains.

### BACKGROUND

The world of cybersecurity is focused on hunting down bad actors.

Existing data certification systems rely solely on user authentication. At best, existing systems such as PGP and S/MIME can encrypt and sign. They are rarely used in practice, and require a high level of administration and technical knowledge on the part of all those who use them.

A disadvantage of this data certification system is that it is based on a single source of information. The solidity of the system depends exclusively on the training of all those involved.

### BRIEF SUMMARY

One aim of the present disclosure is notably to remedy all or part the aforementioned drawbacks.

According to a first aspect of the present disclosure, proposed is a module for processing certifying instances of digital data generated by certifying systems, the module comprising a user identifier, wherein each of the certifying instances is associated with a storage address, with a user terminal, and with a non-repudiable ledger comprising an ordered list of elements, each of the elements comprising:
an attestation generated by one of the certifying systems, the attestation comprising a type of attestation, a document hash, a time stamp by the certifying system of the time at which the attestation was generated,
an electronic signature of the attestation by the certifying system,
a time stamp by the processing module of the time at which the element was added to the ordered list, and
possibly a pointer to the electronic document (for example, a memory address in a network storage device), in clear text or encrypted with an asymmetric key held by the creator of the certifying instance.

According to a second aspect of the present disclosure, proposed is a system comprising at least one client, at least one certifying system, and at least one instance processing module according to the first aspect of the present disclosure, or one or more of its improvements.

According to another aspect of the present disclosure, proposed is a method implemented in a system according to the second aspect of the present disclosure, or one or more of its improvements.

The method can comprise a step for verifying the integrity of a file by a user terminal, the file being received from another user terminal.

The file integrity verification step then comprises the following steps, implemented at the user terminal:
calculating a hash of the received file,
receiving, from the other user terminal, a storage address for a certifying instance,
generating a certifying instance reception request from the storage address and sending it to the module,
receiving, from the module, the certifying instance associated with the storage address, and
browsing the list of elements of the certifying instance received to determine the presence or absence of a hash of an attestation that is the same as the calculated hash.

If the presence of the calculated hash is verified, the file integrity verification step may comprise one or more steps for verifying the other attestations in the ordered list of elements of the certifying instance.

### BRIEF DESCRIPTION OF THE DRAWINGS

Other advantages and particularities of the present disclosure will become apparent on reading the detailed description of implementations and embodiments that are in no way exhaustive, with reference to the appended drawings, in which:

FIG. 1 shows an example embodiment of a system according to the present disclosure,

FIG. 2 shows a use case of a system according to the present disclosure,

FIG. 3 shows the various steps of certification by a system according to the present disclosure, and

FIG. 4 shows an exchange sequence diagram within the system according to the present disclosure.

### DETAILED DESCRIPTION

Since the embodiments described below are in no way limiting, it will, in particular, be possible to consider variants of the present disclosure comprising only a selection of the features described, subsequently isolated from the other features described, if this selection of characteristics is sufficient to confer a technical advantage or to differentiate the present disclosure from the prior art. This selection comprises at least one feature, preferably functional, without structural details, or with only a portion of the structural details if this part only is sufficient to confer a technical advantage or to differentiate the present disclosure from the prior art.

In the figures, an element appearing in a plurality of figures retains the same reference.

### Definitions

Hash: a hash is the result of a hash function that creates an imprint of documents, data, etc. A hash is used to validate data integrity.
Digital certification: a method using encryption and asymmetric cryptography to ensure the provenance of digital data.

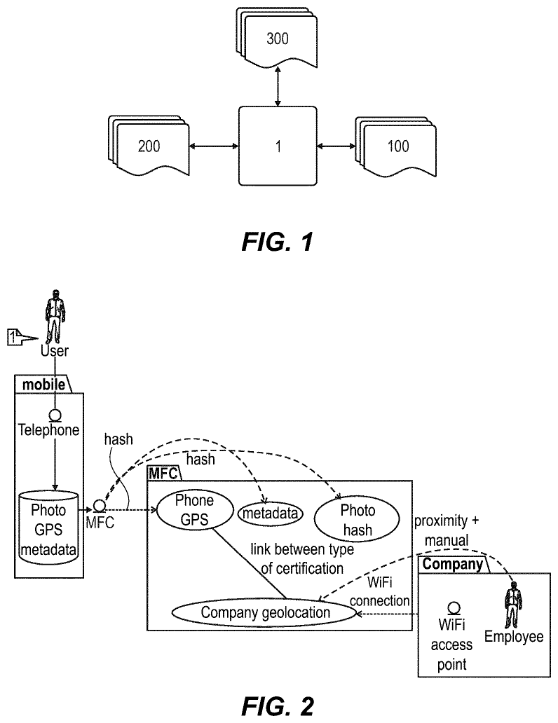

FIG. 1 is a diagram of an embodiment of a system according to the present disclosure.

The system according to the present disclosure comprises: a module 1 for processing certifying instances 100 of digital data generated by certifying systems 300, the module comprising a user identifier 200, and more precisely a public key.

Each certifying instance is associated with a storage address for the instance, a user terminal owning the instance, and an ordered list of elements stored on a non-repudiable ledger.

Each element in the ordered list contains:
an attestation generated by one of the certifying systems, an attestation comprising a type of attestation, a document hash,
a time stamp by the certifying system of the time at which the attestation was generated,
an electronic signature of the attestation by the certifying system,
a time stamp by the processing module of the time at which the element was added to the ordered list, and
possibly a pointer to the document.

A certifying instance can be implemented as a “smart contract” on the non-repudiable ledger, preferably distributed, preferably without permissions, such as a blockchain, or any other implementation that guarantees the non-repudiation of transactions on the ledger.

A certifying instance is initialized by a step of registering a user, identifiable by asymmetric keys, and creating an encryption key for the data stored in the certifying instance.

The module 1 implements a function for adding an attestation to a certifying instance.

The module 1 implements a function for transferring a certifying instance to another user terminal.

The module 1 implements a function for verifying the set of attestations of a certifying instance on receipt of a hash and the certifying instance.

The module 1 can be configured to accept a request to share the attestations making up a ledger of a certifying instance with the authorization of the user owning the MFC.

If a third-party certifying system adds an attestation to a list, the owner of the list may accept or reject the attestation, and becomes the owner thereof in case of acceptance.

### Attestations

An attestation is generated by any certifying system that has data related to the type of attestation requested by a user terminal or other digital system.

An attestation can also be called an assertion, that is, a proposition stated as true, without it necessarily being true. The word “affirmation” can also be used instead of attestation.

An attestation comprises a hash obtained from a file on the certifying system, which validates the type of attestation. An attestation type corresponds to a user terminal assertion type. These may, in particular, include: a file (for example, a photograph, or an audio file), a location, a signature, an audit (for example, a human verification of the systems that generated the hash, or an automated audit), proximity, presence of a witness, a residence, a purchase, a proof of ownership, a delegation.

Delegation allows someone to sign “on behalf” of a person or company. This type of attestation is important to be able to change the key of a certifying system, and to keep a record that the signature was recognized at a date prior to the key change. The attestation is electronically signed and time-stamped by the certifying system, and this signature can be used to identify the company or the person responsible for the signature.

The certifying instance can be configured to encrypt the attestation in its storage using a user terminal's public encryption key, thus making it accessible only to the user terminal associated with the certifying instance, that is, its owner. The owner user's public key will then be used by default to encrypt the attestation.

It is possible for a certifying system to certify the absence of data linked to a user terminal. In this case the hash will have the value “absence verified,” for example, coded by the value −1, or “absence” coded by the value “−2.” The term “absence verified” refers to a case where there is data to prove that the assertion to be certified is false. For example, for the location of a cell phone, the value “absence” means that the system has no data linked to the user terminal.

A previous attestation can be invalidated by adding a new attestation with the “error” hash. The invalidated transaction will be flagged by its identifier in the ledger.

### Example Embodiment of a System According to the Present Disclosure

FIG. 2 shows an example embodiment of a method implemented in a system according to the present disclosure.

A user uses his cell phone to generate a file, which comprises a photograph, located by the cell phone's GPS, and metadata.

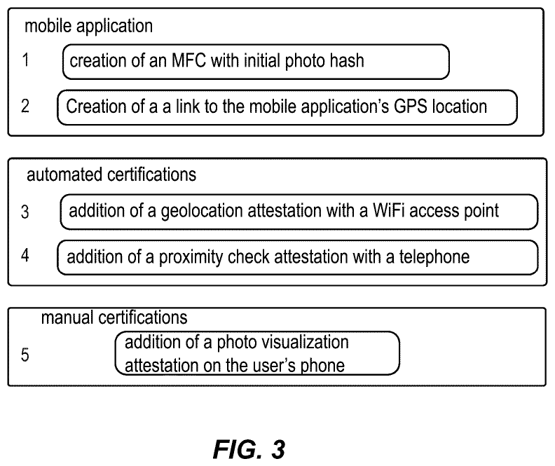

The user sends an instance creation request to the module 1, sending it a hash of the generated file and an electronic signature of the hash, as shown in steps 1 and 2 of FIG. 3.

The module 1 creates an MFC certifying instance associated with the user terminal.

A first element is added to the ledger of the MFC certifying instance. The first element comprises:
an attestation generated by the user, the attestation comprising a file type attestation, the hash of the generated file, a time stamp by the certifying system of the time at which the attestation was generated,
an electronic signature of the attestation, and
a time stamp by the module 1 of the time at which the element was added to the ordered list.

The user then sends an attestation request for this file to a certifying system. To do this, the user terminal sends the certifying system the type of attestation required, as well as sending a user terminal identifier to the company's certifying department. The user terminal identifier is advantageously a public key of a public/private key pair.

In the example shown, the certifying system is designed to certify the user terminal's access to the company's Wi-Fi system, as shown by step 3 of FIG. 3.

On receipt of the request, the certifying system collects data from an information system to generate a file relating to the type of attestation required and the user terminal identifier.

The certifying system then calculates a hash and generates an attestation comprising a time stamp from the certifying system of the time at which the attestation was created. The attestation and its electronic signature are sent to the user terminal.

When the user terminal receives the attestation and electronic signature, it sends these elements, together with the address of the certifying instance, to the module 1.

The module 1 is then configured to add the attestation and its electronic signature as a new element to the ordered list of elements of the instance.

The user can then send a new attestation request for this file to another certifying system.

In the example shown in FIG. 3, step 4, the method involves adding a proximity verification attestation (or link) to an employee's phone.

In the example shown in FIG. 3, step 5, the method further comprises adding an attestation (or link) for photo verification by an employee.

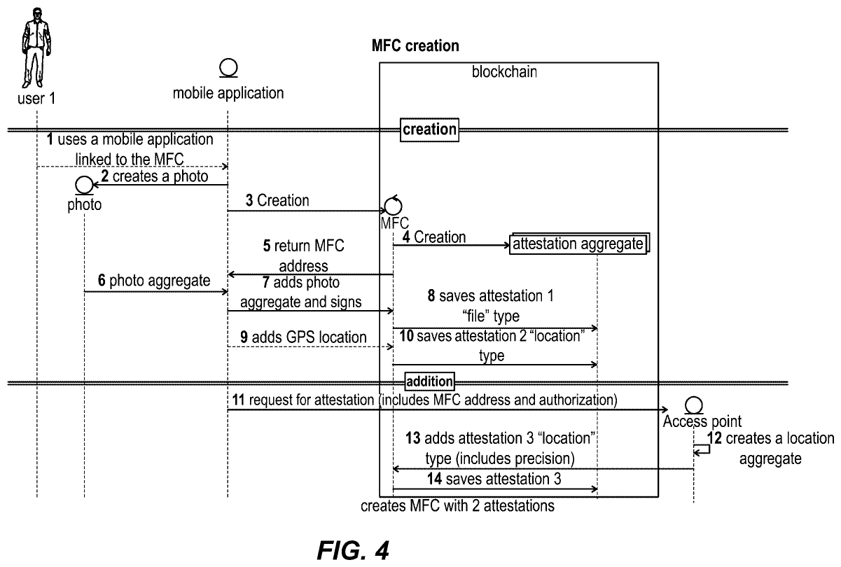

FIG. 4 shows an example of a method sequence implemented in a system according to the present disclosure. The references here are specifically linked to FIG. 4.

A user 1 uses 1 a mobile application configured to communicate with the system according to the present disclosure. The mobile application on the one hand creates a photograph and on the other hand sends 3 an instance creation request to the module, sending it a hash of the generated file and an electronic signature of the hash, as shown in steps 1 and 2 of FIG. 3.

The module creates 4 an MFC certifying instance associated with the user terminal, comprising a ledger.

The module returns 5 an address from the certifying instance to the mobile application.

The mobile application receives 6 an aggregate of the photo.

The mobile application sends 7 a request to add attestations to the module, sending it the address of the certifying instance, a hash of the generated file and an electronic signature of the hash.

A first element is added 8 to the ledger of the MFC certifying instance. The first element comprises:
an attestation generated by the application, the attestation comprising a file type attestation, the hash of the generated file, a time stamp by the certifying system of the time at which the attestation was generated,
an electronic signature of the attestation, and
a time stamp by the module 1 of the time at which the element was added to the ordered list.

As a result, the mobile application requires 9 GPS location to be added to the module.

A second element is added 10 to the ledger of the certifying instance. The user then sends 11 an attestation request for this file to a certifying system. To do this, the user terminal sends the certifying system the type of attestation required, as well as sending a user terminal identifier to the company's certifying department.

In the example shown, the certifying system is designed to certify the user terminal's access to the company's Wi-Fi system.

On receipt of the request, the certifying system collects data from an information system to generate a file relating to the type of attestation required and the user terminal identifier.

The certifying system then calculates a hash 12 and generates an attestation comprising a time stamp from the certifying system of the time at which the attestation was created. In the example shown, the attestation and its electronic signature are sent 13 to the module 1.

The module 1 is then configured to add 14 the attestation and its electronic signature as a new element to the ordered list of elements of the instance.

### Checking File Integrity

The method according to the present disclosure can comprise a step for verifying the integrity of a file by a user terminal, the file being received from another user terminal.

To this end, the user terminal implements the following steps:
calculating a hash of the received file,
receiving, from the other user terminal, a storage address for a certifying instance,
generating a certifying instance reception request from the storage address and sending it to the module (1),
receiving, from the module (1), the certifying instance associated with the storage address, and
browsing the ordered list of elements of the certifying instance received to determine the presence or absence of a hash of an attestation that is the same as the calculated hash.

If the presence of the calculated hash is verified, the file integrity verification step may comprise one or more steps for verifying the other attestations in the ordered list of elements of the certifying instance.

To this end, the user terminal can send a verification request, for example, iteratively, to each of the certifying systems, comprising the attestation.

On receipt of the verification request, the certifying system can verify the integrity of the attestation by recalculating the hash linked to the file used to generate the attestation, and comparing it with the hash contained in the received attestation. If the two hashes are the same, the certifying system sends a positive response to the user terminal; otherwise, it sends a negative response.

In this way, the user terminal can check the integrity of the received file with several certifying systems, thus increasing its confidence in the integrity of the received file.

For example, the module is implemented as a processing or computing unit configured to implement the various functionalities disclosed.

Also proposed is a computer program product that comprises instructions that, when executed by a computing unit of a computer, implement the various functionalities of the module.

In other words, the module can be implemented via a set of software (specific computer program product) and/or hardware (FPGA, PLD, ASIC, etc.) configured means for controlling implementing the various functions.

Of course, the present disclosure is not limited to the examples that have just been described and numerous modifications can be made to these examples without departing from the scope of the invention as defined by the claims. In addition, the different features, forms, variants and embodiments of the present disclosure may be associated with one another in various combinations insofar as they are not incompatible or exclusive of one another.

1. A module for processing certifying instances of digital data generated by certifying systems, the module comprising a public key of a user terminal,
wherein each of the certifying instances is associated with a storage address, with a user terminal, and with an ordered list of elements stored on a non-repudiable ledger, each of the elements comprising:
an attestation generated by one of the certifying systems, the attestation comprising a type of attestation, a document hash, a time stamp by the certifying system of the time at which the attestation was generated,
an electronic signature of the attestation by the certifying system, and
a time stamp by the processing module of the time at which the element was added to the ordered list.

2. A data certification system comprising at least one user terminal, at least one certifying system, and an instance processing module according to claim 1.

3. A data certification method implemented in a data certification system according to claim 2, comprising a step of verifying the integrity of a file by a user terminal, the file being received from another user terminal, the step comprising the following steps, implemented at the user terminal:
a. calculating a hash of the received file,
b. receiving, from the other user terminal, a storage address for a certifying instance,
c. generating a certifying instance reception request from the storage address and sending it to the module,
d. receiving, from the module, the certifying instance associated with the storage address, and
e. browsing the ordered list of elements of the certifying instance received to determine the presence or absence of a hash of an attestation that is the same as the calculated hash.

4. The module of claim 1, wherein each of the elements further comprises a pointer to the document.
